(19) United States
(12) Patent Application Publication
(10) Pub. No.: US 2019/0287298 A1
(43) Pub. Date: Sep. 19, 2019

(54) SYSTEM AND METHODS FOR REPRESENTING SEISMIC CROSS-SECTIONAL AND ANALOGOUS DATA IN A THREE-DIMENSIONAL GEOGRAPHIC INFORMATION SYSTEM

(71) Applicants: Scott David Morris, Playa Del Rey, CA (US); Anthony Kalani Dupont, Huntington Beach, CA (US); John Daniel Grace, Long Beach, CA (US)

(72) Inventors: Scott David Morris, Playa Del Rey, CA (US); Anthony Kalani Dupont, Huntington Beach, CA (US); John Daniel Grace, Long Beach, CA (US)

(73) Assignee: Earth Science Associates, Inc., Long Beach, CA (US)

(21) Appl. No.: 16/289,537

(22) Filed: Feb. 28, 2019

Related U.S. Application Data
(60) Provisional application No. 62/642,695, filed on Mar. 14, 2018.

(51) Int. Cl. G06T 17/05; G01V 1/28; G06T 15/04

(52) U.S. Cl. CPC G06T 17/05; G06T 15/04; G01V 1/282

(57) ABSTRACT

The present invention comprises a system and methods for the conversion of time-recorded seismic data, or images made from them after conversion of time to depth, into data structures that can be imported into and used in a three-dimensional geographic information system. The system and methods are robust with respect to the forms in which the seismic data is input into the invention. The system is general in that it is applicable to cross-sectional data other than those derived in seismic surveys and requires very non-restrictive definitions of cross-sectional planes, their orientations and datums with respect to the volumes they intersect.

### CROSS-REFERENCE TO RELATED APPLICATIONS

Provisional Patent Application U.S. 62/642,695 filed Mar. 14, 2018

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not applicable

### U.S. PATENTS REFERENCED

U.S. Pat. No. 6,989,841 B2, Docherty, Jan. 24, 2006; U.S. Pat. No. 8,605,951 B2, Baggs et al., Dec. 10, 2013.

### FIELD OF THE INVENTION

The present invention provides a novel solution for the introduction of two-dimensional seismic profiles, and analogous cross-sectional data, into a three-dimensional geographic information system. More particularly, it creates a data structure of equivalent geographic dimensions to those of the seismic, or other cross-sectional data, and textures that data structure with processed, georegistered information from the source.

### BACKGROUND OF THE INVENTION

Reflection seismic data is used to characterize the subsurface geology of an area. The purposes of this work include mineral exploration and production, identification of faults that may be associated with earthquakes, measuring rock properties used in engineering projects and other scientific and technical research. Since its invention in the second decade of the 20^{th} century, hundreds of thousands of reflection seismic surveys have been conducted worldwide.

Typically, a controlled acoustic energy pulse is introduced at the earth's surface (e.g., by firing an air gun offshore or using a “thumper” truck onshore) at successive locations along a pre-defined transect. After it is induced, the pulse travels into the earth as a wave and some of its energy is reflected back to the surface by subsurface geologic features. The amplitude, frequency and geometry of the reflected energy are based on the characteristics of the induced pulse and on differences in the acoustic impedances of the encountered rocks and the fluids and gases they contain. Data on the depth and orientation, as well as other characteristics of the reflecting features, can be obtained by measuring the time between induction of the acoustic pulse at the surface and when reflections are received back at the surface, as measured by specialized receivers.

In its most basic implementation, the results of a single reflection seismic survey are summarized in a cross-section extending laterally over the length of the survey (FIG. 3) and to the depth below the earth's surface over which usable seismic reflection data has been collected (FIG. 9). This cross-section is usually called a two-dimensional (2D) seismic line or section. Commonly, a grid of multiple, often perpendicular, 2D seismic lines are collected in an acquisition program, with orientation and inter-line spacing determined by technical parameters. In more recent implementations, special surveys and processing have been designed, based around tightly spaced lines, to directly produce three-dimensional (3D) models of subsurface features, identified by their seismic reflections.

The data acquired in seismic surveys is usually recorded in two related types of sets. The relative locations of where the reflected waves were recorded, their measured travel times and related characteristics, are stored in files generally known as SEG-Y. A SEG-Y file is a matrix in which the columns, called traces, correspond to the lateral location along the transect at which data were collected. The values in the matrix, called samples, record the measured coefficients of reflection, and other data, obtained at uniform increments of time following the induction of the acoustic pulse at which the reflections were received at the surface (typically measured in milliseconds). Data that associate the geographic locations of traces along the survey transect are often called a SEG-P1 , or generically, “navigation” data.

After acquisition and basic processing, these data are typically loaded into computers with special-purpose software for further processing and interpretation of geologic features in the subsurface covered by the seismic line. The seismic data, recorded in time, and any interpretations made of the time-section, are usually converted from time to geographic depth (e.g., with respect to sea level) based on estimates of the velocities of acoustic energy through the subsurface in the neighborhood of the survey.

Depending on the uses to which the seismic data and its interpretation will be put, an interpreter of seismic data (e.g., a geophysicist, geologist or engineer) may have related data and analysis stored independently in a geographic information system (GIS). GIS software stores, manages, analyzes and visualizes spatial data in two dimensions, usually representing laterally distributed features on the earth's surface or in three dimensions; it can also include the vertical dimension of features distributed in the lithosphere, atmosphere or hydrosphere.

In 3D GIS software, well paths, the locations of samples taken from them, the estimated mapped tops of geologic formations, the planes along which faults move, 3D models of oil and gas reservoirs and other subsurface features can all be represented. These elements can also be analyzed within the 3D GIS, focusing on both logical and spatial subsets of the data and the relationships between them and creating new data by 2D and 3D mathematical and statistical techniques applied to those data.

However, there is no mechanism for representing 2D seismic lines, or volumes created from 3D seismic surveys (composed of multiple 2D seismic lines), in a 3D GIS. Therefore, the information carried by these seismic surveys cannot be used for visualization of the subsurface with other 2D and 3D data in the 3D GIS. As well, it is not possible to analyze data contained in the 2D and 3D seismic surveys with respect to other data the 3D GIS include.

The lack of a mechanism to convert cross-sectional data for representation in 3D GIS is general and also applies, for example, to cross-sections of geologic, geochemical, hydrologic, atmospheric data or any field variables that exist in three dimensions within a defined volume. As used here, the term cross-section refers to the organization, on a plane, of observed and/or interpreted data from a three-dimensional volume in the neighborhood of the intersection of the plane and the volume. A cross-section used in the geosciences is typically constructed on a simple (i.e., flat) plane, perpendicular to the surface of the earth and extending downward below the surface. However, as used here, this definition is general: including piece-wise linear and curvilinear surfaces, angles of intersection between the plane and the volume that are not perpendicular, planes not limited to extending toward the center of the volume and planes from surface datums that can be established anywhere in the three-dimensional volume.

The prior art contains some inventions that make an attempt to overcome this problem, but they lack essential features or the implementation yields unsatisfactory results. For example, U.S. Pat. No. 6,989,841 B2 attempts to visualize seismic data in plan view (overhead 2D view) but does not fully realize the data in three-dimensional geographic space. U.S. Pat. No. 8,605,951 B2 describes a method to convert digital images to multi-dimensional space by creating a spatial data structure with the same dimensions of the image data. For extremely small images, this may be feasible, but for realistic uses the GIS renders the object so slowly that it is not useable and can cause the GIS software to crash.

### BRIEF SUMMARY OF THE INVENTION

Two-dimensional GIS technology is very widely used in physical, biological, social science and engineering applications and research. Its 3D extension is increasingly used, with its pace of adoption at least partially dependent on the availability of mechanisms to input different types of 3D data into it. The present invention resolves a significant current limitation in the application and uses of 3D GIS technology arising out of the absence of systems and methods for incorporating cross-sectional data within them.

The preferred application of this invention is with seismic data. In its preferred application to seismic data, the present invention makes 2D and 3D seismic data accessible to 3D GIS technologies by providing a method and system for constructing 2D cross-sections from the combination of digital seismic images and the accompanying navigation data from the seismic surveys. Alternatively, the invention also details how to create digital seismic images directly from the SEG-Y files that hold the seismic data to be placed into the 3D GIS in the case an image is not already available. The system utilizes the navigation data provided with the seismic data to establish the location of seismic surveys on the earth's surface. Depth data provided by the user is then used by the system to fully describe the location of the seismic data in real geographic units in three dimensions. Finally, the system georegisters (uses control points on a correctly placed geographic data structure to project a non-registered component into geographic space) the seismic data by texturing the 3D GIS object with the seismic image. Within the 3D GIS, the created object can be viewed and analyzed in the same way as any other GIS data.

This summary is a very simplified overview of the invention and is not intended to identify essential features or limit the scope of the invention. In fact, the invention is general enough to be used with any cross-sectional data that could be represented in a three dimensional space. For example, while seismic data is beneath the earth's surface, this invention can also be used to represent atmospheric data. Additionally, the system accommodates complex navigation data that may be piecewise linear or curvilinear. A more complete understanding of the invention and its advantages are present in the remaining portion of the specifications.

### BRIEF DESCRIPTION OF DRAWINGS

A preferred embodiment of the present invention is illustrated in these examples and the invention is not limited by the figures of accompanying drawings:

FIG. 1 is a seismic image that depicts a seismic section with a very pronounced salt dome. The alternating largely white and largely black lines, roughly parallel to the earth's surface, represent the boundaries of shale and sandstone rock layers between the seafloor and the maximum depth of the seismic cross-section. The image is created from SEG-Y data that has accompanying SEG-P1 navigation data. The transect of this seismic section along the surface of the earth is 11 miles long and was acquired along a straight path (see FIG. 3).

FIG. 2 is a seismic image that depicts a seismic section. The image is created from SEG-Y data that has accompanying SEG-P1 navigation data. The transect of this seismic section along the surface of the earth is 12.2 miles long and, unlike FIG. 1, was acquired along a piece-wise linear path (see FIG. 4).

FIG. 3 depicts the navigation data of the seismic image in FIG. 1 (dark line). The light grid of lines represents a lateral coordinate system. In this example, and the figures that follow, the lateral coordinate system is based on latitude and longitude and is reflected in the boundaries of blocks (usually 3 miles square) established by the US government for leasing of mineral rights in the Gulf of Mexico. The coordinate system, and seismic navigation data locate the transect on the earth's surface.

FIG. 4, like FIG. 3, depicts the navigation data of the seismic image in FIG. 2 (dark line). However, in distinction to FIG. 3, FIG. 4 depicts a transect which is not a simple line but comprised of piece-wise linear components.

FIG. 5 depicts the extension, in depth, of the navigation data shown in FIG. 3. The grey plane in the figure represents the boundary, location and orientation of the 3D GIS data structure used (e.g., a multipatch) on which the cross-section data will be applied as a texture. The perspective of view is from below the earth's surface; the depth of the bottom of the grey image is approximately 6 miles below sea level and the top is at sea level.

FIG. 6, like FIG. 5, depicts the extension in depth of the navigation data shown in FIG. 4. The grey plane follows the piece-wise linear components of the navigation data to a depth of about 6 miles. The perspective of view is from above the earth's surface.

FIG. 7 depicts the process of georegistering the image from FIG. 1 to the 3D GIS object (e.g., a multipatch) in FIG. 5. Here the process is simple as the navigation data for this seismic section is a straight line, as shown in FIG. 3.

FIG. 8 depicts the process of georegistering the image from FIG. 2 to the 3D GIS object (e.g., a multipatch) in FIG. 6. Here, several anchor points are needed as the navigation data for this seismic section is not a simple line, as shown in FIG. 4.

FIG. 9 depicts the 3D GIS data structure (e.g., a multipatch), referenced in FIG. 5, after it has been textured with the seismic image from FIG. 1. The perspective and the dimensions of the seismic cross-section are the same as in FIG. 5.

FIG. 10, like FIG. 9, depicts the 3D GIS Data structure (e.g., a multipatch), referenced in FIG. 6, after it has been textured with the seismic image from FIG. 1. The perspective and dimensions of the seismic-section are the same as in FIG. 6.

FIG. 11 depicts the same seismic cross-section as in FIG. 9, except that, in the 3D GIS scene into which it was imported, additional 3D spatial information has been added for visualization and analysis. The black lines extending from the surface represent the paths of oil and gas wells and the grey to black 3D polygonal features, which some of the wells intersect, are models of the boundaries of oil and gas reservoirs.

### DETAILED DESCRIPTION OF THE INVENTION

The steps in this detailed description are focused on the preferred implementation of the invention for the importing, display and analysis of 2D seismic sections in a 3D GIS, however the steps are general enough that they can be used in other implementations. The preferred implementation is based on software produced by Environmental Systems Research Institute, Inc. (Esri).

Step 1 includes obtaining a digital image of the seismic data, converted from time to depth, to place into the 3D GIS. Such an image can be obtained in at least three ways:
1. The seismic data from a survey along a transect, as recorded in time and stored in the SEG-Y (or related formats), is imported into the system and processed to convert the observations from time to depth, typically using exogenous information (e.g., velocity surveys). Further processing may also be applied to highlight and/or suppress observation attributes to assist the interpretation and analysis of the cross-section. The result is an image of the processed seismic recorded in a widely used format (e.g., jpeg).
2. An image of the seismic section, in depth, can be exported in a widely used format (e.g., jpeg) from special purpose seismic processing and interpretation software (e.g., the Kingdom package, produced by IHS Markit). Such an exported digital image often has marginalia (e.g., a title box giving parameters of acquisition and processing), which are cropped by the invention. Additionally, such an exported image may have overlaid on it integrated geologic interpretation of geologic features (which were not included in the original SEG-Y) and may be retained in the process for display and analysis in the 3D GIS.
3. Beyond the preferred implementation, any printed image or scale drawing (in geographic units in lateral and vertical dimensions) can be scanned into a common image format (e.g., jpeg). With the use of an associated location map, the image can be registered on the earth's surface to compute the geographic coordinates of the transect. The vertical extent of the image in physical units is obtained from the vertical axis of the scanned image and the 1:1 ratio of vertical to lateral distance induced by stretching or compressing the image.

There is no restriction on the size and shape of the digital image (except the limitation of the computing system itself) as the system will stretch/compress it appropriately.

In the embodiment of the invention described here, the original SEG-Y data (with observations measured in time) are read directly and converted into an image by classifying the reflection coefficient values and mapping the classification values to particular colors. Classification here is by computing the mean and the standard deviation of all values in the single seismic line being processed. Then, the reflection coefficient of each observation is binned based with respect to its (signed) standard deviations from zero. The bin boundaries used for classification may change depending on the analytic goal of the project.

Once transformed into positive and negative standard deviation bin scores, positive scores are typically colored using one color ramp (e.g., white to blue), in which the lowest-score observations are assigned to white and the highest-score observations are assigned to the darkest color (e.g., dark blue). Negative scores are similarly symbolized in a different range (e.g., white to red), with the same saturation gradient direction (i.e., increasing in absolute values).

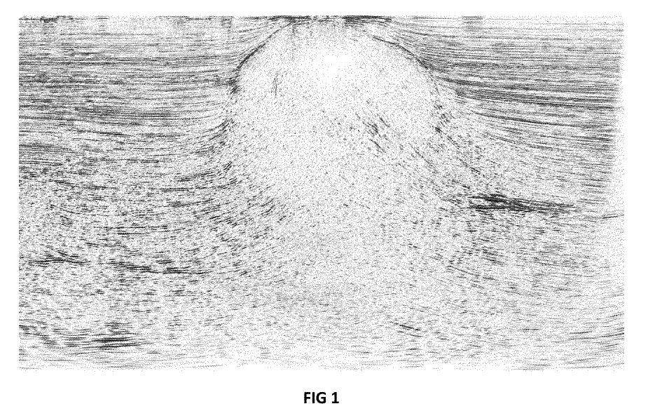

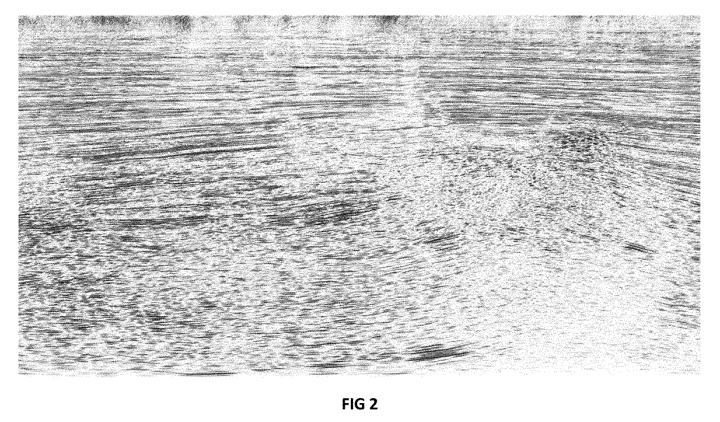

In this way, the original SEG-Y reflection coefficient data image is transformed such that every pixel corresponds to a cell in the original SEG-Y file (i.e., the number of pixels in the image is the same as the total number of samples in the SEG-Y file). The colors of the pixels represent the positive and negative distances from zero (as measured by the value of the standard deviation). White pixels represent values equal to or close to zero and the values away from zero are represented by increasingly saturated colors. In FIG. 1 and FIG. 2 a single white to black ramp, reflecting the absolute values of the standard deviations at each cell, has been used because of the limitation of figures to a grey scale (i.e., white to black representing increasing saturation and observation distance from zero).

The image is then transformed to depth by assuming a constant velocity function with respect to depth and lateral extent. However, in practice, the velocity of the seismic wave through the rock can change laterally so it may be necessary to divide the seismic line into sections where the velocity of the seismic wave through the rock is approximately constant. The velocity of the seismic wave through the rock may also change with depth. In this case, further processing of the seismic data may be necessary or errors in the time-to-depth transformation can occur. Further processing may also be required in the case of marine seismic to adjust the depth data due to the influence of water (which is generally linear in its depth) over which the seismic data were acquired.

Step 2 consists of determining the lateral extent of the seismic line along the transect of the earth's surface and creating a 2-dimensional GIS object that holds this information. For lateral geographic control on the seismic line, the system accepts a SEG-P1 file for the navigation, a generic text file with x/y coordinate pairs given or manual entry. As navigation data is commonly recorded in a variety of geographic projection systems, use of the invention with the target 3D GIS software (e.g., ArcGIS produced by Esri) typically provides support for a wide range of coordinate systems (geographic and projected) transformations.

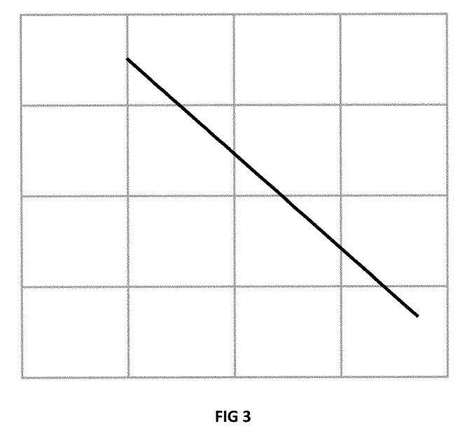

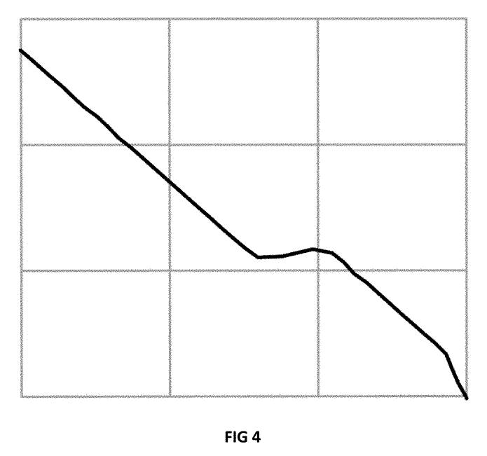

As described in the examples here, the survey included both SEG-Y data and the associated SEG-P1 file as navigation data. The raw navigation file listed the lateral coordinates in degrees, minutes, decimal seconds using the NAD 1927 coordinate system. While navigation files can be comprised of numerous data points (in order to accurately capture the path along which the data was acquired) the examples here have only 2 (FIGS. 3) and 5 (FIG. 4) navigation points. This is for ease of understanding the invention as the system is capable of processing any number of navigation points (so long as they fit in the computer system's memory).

The preferred implementation of the invention makes use of Esri's ArcObjects and stores the collection of navigation data as a PointCollection which is transformed into a Polyline via the IGeometryCollection. The Points that make up the PointCollection are taken directly from the navigation data and transformed into the World Geodetic System (WGS 1984) and in turn the Polyline object is also in the WGS 1984. The output of this step is seen in FIG. 3 as a simple line on the surface of the earth. Navigation data that is not a simple line may also able to be processed by this invention and an example is shown in FIG. 4.

Step 3 consist of extruding the GIS object that holds the navigation data created in Step 2 into a three-dimensional GIS object that matches the true 3D geographic location of the seismic data. If the seismic data's shallowest observation is on the surface of the earth, this step simply involves extruding the 2D navigation data to the maximum depth of the seismic data. If the shallowest observation is beneath the surface of the earth, the 2D navigation data must first be lowered to the depth of the shallowest observation and then extruded to the maximum depth of the seismic data. Typically the shallowest observation will be on the surface of the earth or sea level.

The preferred implementation of the invention extrudes the Polyline via the IconstructMultipatch to create a Multipatch object which follows the navigation data but is extruded to the specified depth. The Multipatch object is Esri's implementation in ArcObjects of the multipatch, which is defined as “a geometry used as a boundary representation for 3D objects.” The Multipatch used in this example of the preferred implementation has equivalent data structures in other 3D GIS software that may be used instead. The Multipatch is created by defining the coordinates of the vertices in x, y and z. The z-coordinate is always either the shallowest observation of the seismic section (0 in the case the seismic data begins at the surface or sea level) or the maximum depth of observations from the seismic section. The x and y-coordinates are taken directly from the result of Step 2. That is, the x and y-coordinates for the vertices of the Multipatch are the same as the navigation data for the seismic section. The Multipatch is constructed by specifying all of the coordinates in sequence, alternating between the depth of the shallowest observation (0 in the case the seismic data begins at the surface or sea level) and the maximum depth of the observations. The set of x,y,z coordinates specified become the vertices of the Multipatch.

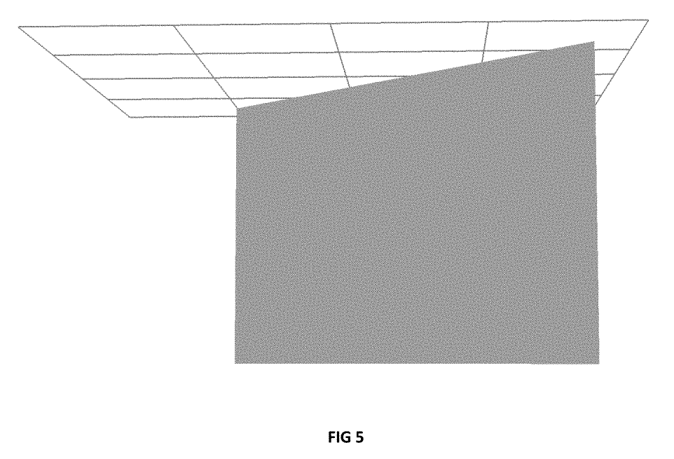

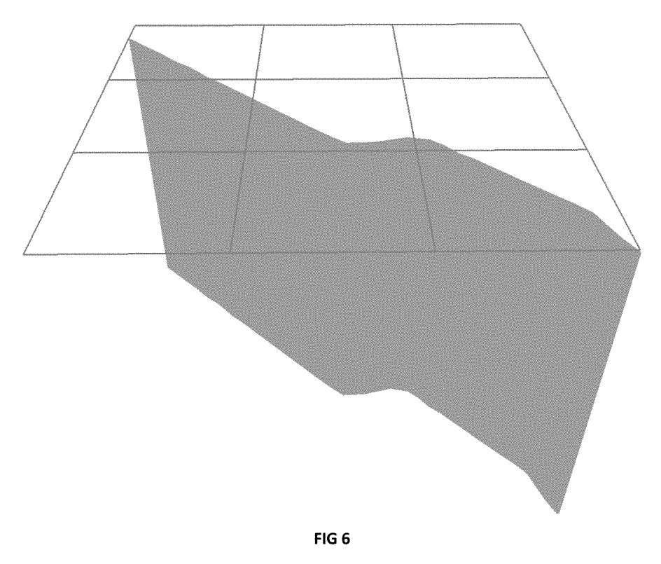

The navigation data used in this example is a simple line with the output of this step seen in FIG. 5. However, if the output of Step 2 is not a simple line, the output of this step would be similar to FIG. 6.

Step 4 consists of registering the seismic image from Step 1 to the 3D GIS object of Step 3. This involves mapping locations on the image to corresponding locations on the 3D GIS object which will serve as anchor points. The top and bottom of the image are easy to register as the top of the image is simply assigned to the shallowest location of the 3D GIS object and the bottom of the image to the deepest location of the 3D GIS object. Lengthwise, the image is mapped to the vertices of the 3D GIS object (that originate from the navigation data) based on the ratio of the lateral length of the vertex from the beginning of the 3D GIS object to the entire lateral length of the 3D GIS object.

In the preferred implementation of the invention, the seismic image is registered to the Multipatch created in Step 3 by assigning every vertex of the Multipatch a corresponding location in the seismic image from Step 1. The location on the digital image is assigned by percent from the left of the image and percent from the top of the image (it is convenient to write this as L %, T % where L is the percentage from the left of the image and T is the percentage from the top of the image). The first vertex of the Multipatch (located at the shallowest observation at the start of the navigation data) is assigned the 0%, 0% location (upper left corner) of the seismic image. The second vertex of the Multipatch is directly beneath the first at the deepest observation is assigned the 0%, 100% location (bottom left corner) of the seismic image. The third vertex is back to the top of the Multipatch and is assigned the X %, 0% location of the seismic image where X % is the percentage that vertex is with respect to the total lateral length of the navigation data. That is, if the vertex is located 10% of the total distance of the navigation data from the beginning of the navigation data, then the horizontal location on the image assigned to that vertex is 10% from the left of the image. This process continues until reaching the final vertex of the Multipatch which is assigned the 100%, 100% location on the image (bottom right). In some cases the digital image may need to be flipped horizontally to properly match with the starting vertex of the Multipatch. The system also accommodates such cases.

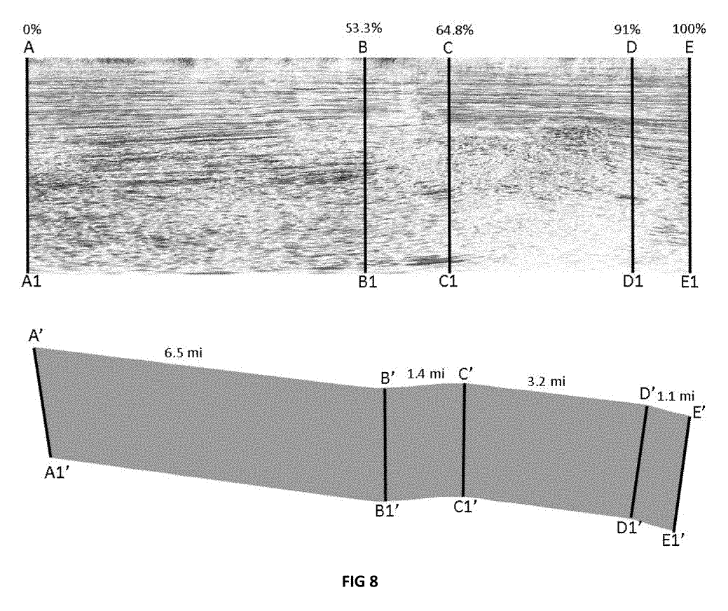

FIG. 8 serves as an example for Step 4. Here, the navigation data contains 5 points (A′, B′, C′, D′ and E′) with a total length of 12.2 miles with segment lengths as shown in FIG. 8. Locations A (0%, 0%) and A1 (0%, 100%) on the image will be assigned to A′ and A1′ on the Multipatch respectively. This is simply anchoring the beginning of the image to the beginning of the Multipatch. The next navigation point, B′, is 6.5 miles away from the beginning of the navigation data. Since this is 53.3% of the total length of the transect, the corresponding location on the image is also 53.3% from the beginning of the image. Thus B (53.3%, 0%) is assigned to B′ and B1 (53.3%, 100%) is assigned to B1′. This process continues until all vertices of the Multipatch have been assigned locations corresponding to the image. It should be noted again that typical navigation data is comprised of much more than five points like in this example, but the process is exactly the same.

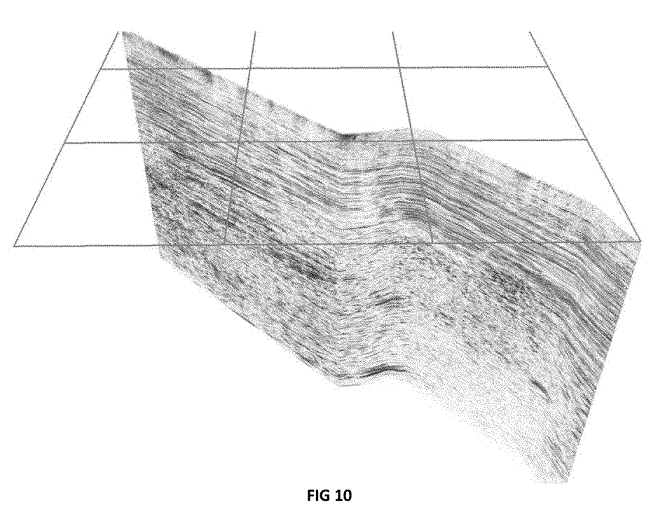

Once every vertex has been assigned a corresponding location on the image, the image is draped over the Multipatch, anchored at the assigned locations. The unassigned locations on the image are stretched linearly (both vertically and horizontally) to fit the shape of the Multipatch between the anchor points. A multipatch that has been assigned an image in this way is referred to as a textured multipatch. FIG. 10 shows the result of this process.

Since the image is stretched linearly in the vertical direction across the Multipatch, it is critical the seismic image is already in depth so it maintains the proper dimensions when placed on the Multipatch. Additionally, this assumes that the horizontal dimension of the image is in a constant relationship with the navigation data. This is typical (especially with seismic data), however if the image is an amalgamation from multiple sources or when using some other kind of cross-sectional data, it may not always be the case. The only change required is that the user must supply the percentages since it cannot be inferred from the navigation data. The system accommodates such cases.

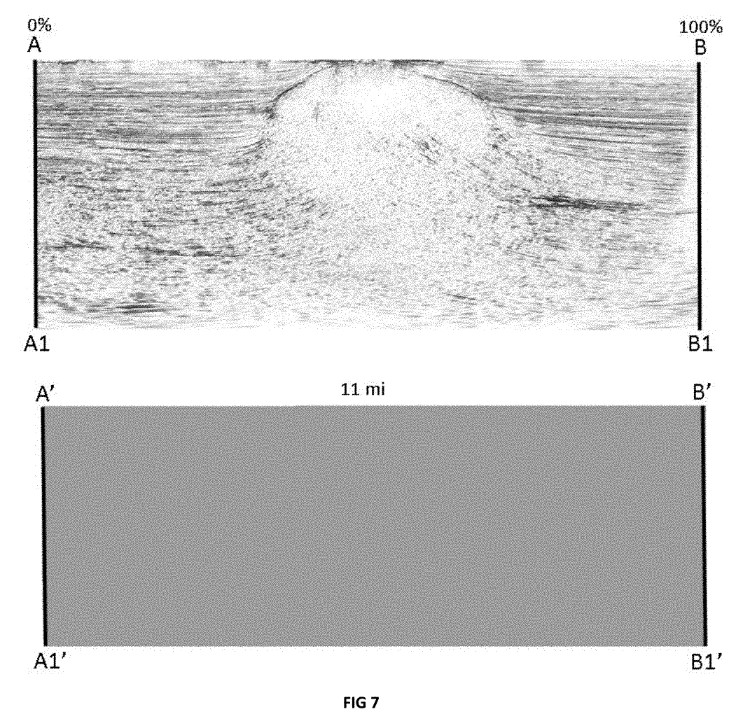

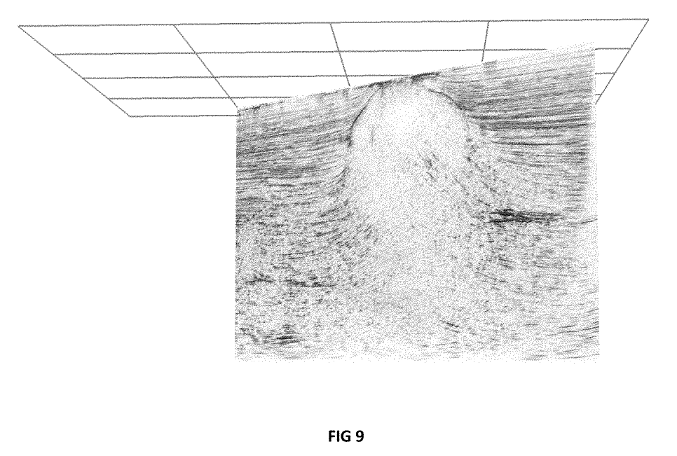

In the example on FIG. 7, the seismic line is fully described as a simple plane, the Multipatch only has 4 vertices (the corners of the grey rectangle). The first vertex of the Multipatch (located at the shallowest observation) is assigned the upper left corner of the digital image and the second vertex of the Multipatch (located directly beneath the first vertex, approximately 6 miles below sea-level in this example) is assigned the bottom left corner of the digital image. Likewise, the third and fourth vertex of the Multipatch are assigned the upper right and bottom right corner of the image. The result of the textured multipatch is shown in FIG. 9.

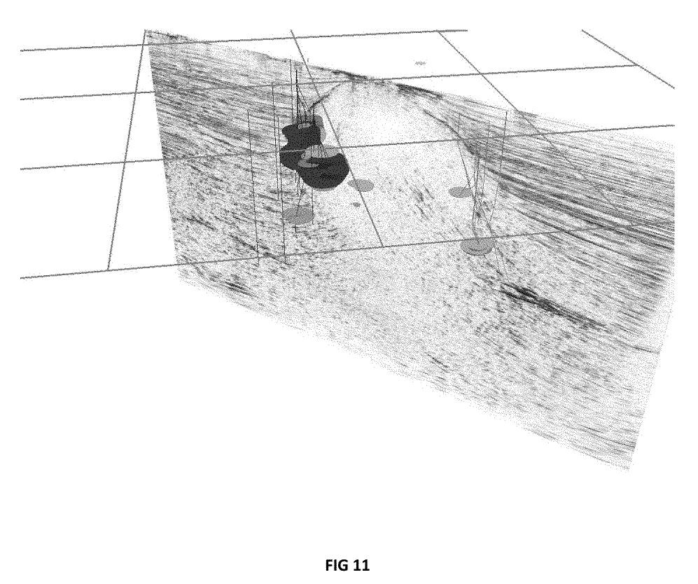

Step 5 consists of saving the object created in Step 4 and importing it into a 3D GIS scene. Typically this object would be saved to a hard drive so it would persist on the machine. In the preferred implementation of the invention, the textured multipatch is saved to the hard drive in an ArcGIS geodatabase since other file storage systems within ArcGIS do not support multipatches with textures. The ArcGIS geodatabase is Esri's implementation of a file system that stores and manages geographic datasets. The textured multipatch is then imported into the 3D GIS scene. The texture displays on both sides of the multipatch, it is correctly placed in three-dimensional geographic space and can be viewed alongside other 3D GIS data available and loaded into the same scene (FIG. 11). Each multipatch, representing a single seismic depth section, may also carry associated attribute data, giving information about the section, which may be displayed, queried and analyzed individually or with respect to other data in the 3D GIS.

What is claimed is:

1. A system and processes for importing data from a seismic survey, in which observations may originally be recorded in time, with accompanying geographic location data of the transect, into a three-dimensional geographic information system (3D GIS). The system and processes consist of:
a. A method to input seismic data measured in time, conversion from time to depth, symbolization of the observations as colored pixels and registration of the data in the lateral and vertical dimensions to place an image in measured 3D geographic space.
b. In the alternative, the system may take as input an existing scanned image of data, measured in geographic space, in which the observations are represented by the color of pixels.
c. A method for construction of a 3D GIS data structure (e.g., a multipatch) corresponding to the measured geographic dimensions and extents of the input seismic data.
d. A method for georegistering the seismic image by texturing the 3D GIS data structure (e.g., multipatch) with the image.
e. A method importing the textured 3D GIS data structure (e.g., multipatch) into a 3D GIS for display and analysis.

2. A generalization of claim 1 such that the system developed in this invention may be applied to any cross-sectional data that can be rendered by these methods into a georegistered image, applied as texture to a spatially coincident 3D GIS data structure (e.g., a multipatch) and imported into a 3D GIS for visualization and analysis, including with other data in that 3D GIS.
